(19) United States
(12) Patent Application Publication
(10) Pub. No.: US 2015/0110068 A1
(43) Pub. Date: Apr. 23, 2015

(54) SERVING CELL AND NEIGHBOR CELL PATH LOSS RATIO REPORTING

(71) Applicant: QUALCOMM Incorporated, San Deigo, CA (US)

(72) Inventors: Ming YANG, San Diego, CA (US); Tom CHIN, San Diego, CA (US)

(73) Assignee: QUALCOMM Incorporated, San Diego, CA (US)

(21) Appl. No.: 14/061,551

(22) Filed: Oct. 23, 2013

(51) Int. Cl. H04W 36/00; H04W 52/24

(52) U.S. Cl. CPC H04W 36/0061; H04W 52/242
USPC 370/331

(57) ABSTRACT

A method of wireless communication includes receiving a list of neighbor cells and determining whether each of the neighbor cells in the list of neighbor cells has a path loss below a threshold value. The method also includes calculating a serving neighbor path loss (SNPL) based on a serving cell and only the neighbor cells having path loss below the threshold value.

### TECHNICAL FIELD

Aspects of the present disclosure relate generally to wireless communication systems, and more particularly, to serving cell and neighbor cell path loss ratio reporting.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China is pursuing TD-SCDMA as the underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, high speed downlink packet access (HSDPA) and high speed uplink packet access (HSUPA), which extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

In one aspect, a method of wireless communication is disclosed. The method includes receiving a list of neighbor cells. The method also includes determining whether each of the neighbor cells in the list of neighbor cells has a path loss below a threshold value. The method further includes calculating a serving neighbor path loss (SNPL) based on a serving cell and only the neighbor cells having path loss below the threshold value.

Another aspect discloses a wireless communication apparatus having a memory and at least one processor coupled to the memory. The processor(s) is configured to receive a list of neighbor cells. The processor(s) is also configured to determine whether each of the neighbor cells in the list of neighbor cells has a path loss below a threshold value. The processor(s) is further configured to calculate a serving neighbor path loss (SNPL) based on a serving cell and only the neighbor cells having path loss below the threshold value.

In another aspect, a method of wireless communication is disclosed. The method includes transmitting a list of neighbor cells. The method also includes receiving a serving neighbor path loss (SNPL) report based on a serving cell and only the neighbor cells in the list of neighbor cells having a path loss below a threshold value.

Another aspect discloses a wireless communication apparatus having a memory and at least one processor coupled to the memory. The processor(s) is configured to transmit a list of neighbor cells. The processor(s) is also configured to receive a serving neighbor path loss (SNPL) report based on a serving cell and only the neighbor cells in the list of neighbor cells having a path loss below a threshold value.

### BRIEF DESCRIPTION OF THE DRAWINGS

For a more complete understanding of the present disclosure, reference is now made to the following description taken in conjunction with the accompanying drawings.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates neighbor and serving cell coverage areas according to aspects of the present disclosure.

FIG. 5 is a block diagram illustrating a wireless communication method for reporting serving neighbor path loss according to aspects of the present disclosure.

FIG. 6 is a block diagram illustrating a wireless communication method for receiving serving neighbor path loss reports according to aspects of the present disclosure.

FIG. 7 is a block diagram illustrating an example of a hardware implementation for an apparatus employing a processing system.

FIG. 8 is a block diagram illustrating another example of a hardware implementation for an apparatus employing a processing system.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

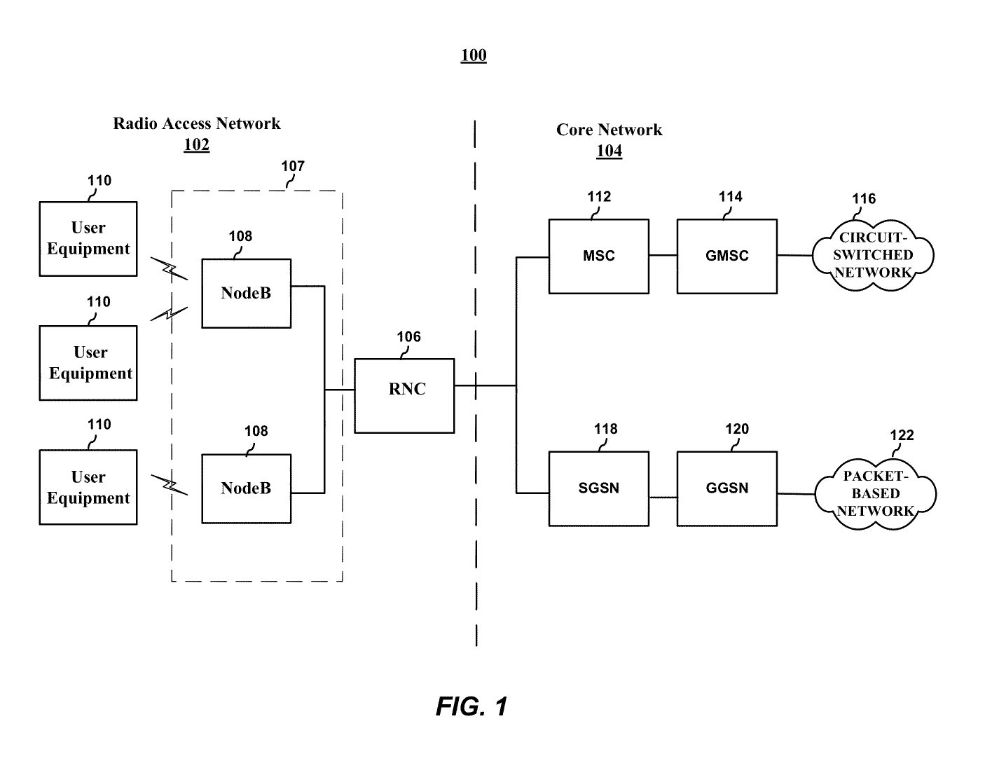

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of radio network subsystems (RNSs) such as an RNS 107, each controlled by a radio network controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving general packet radio service (GPRS) support node (SGSN) 118 and a gateway GPRS support node (GGSN) 120. GPRS is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum direct-sequence code division multiple access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

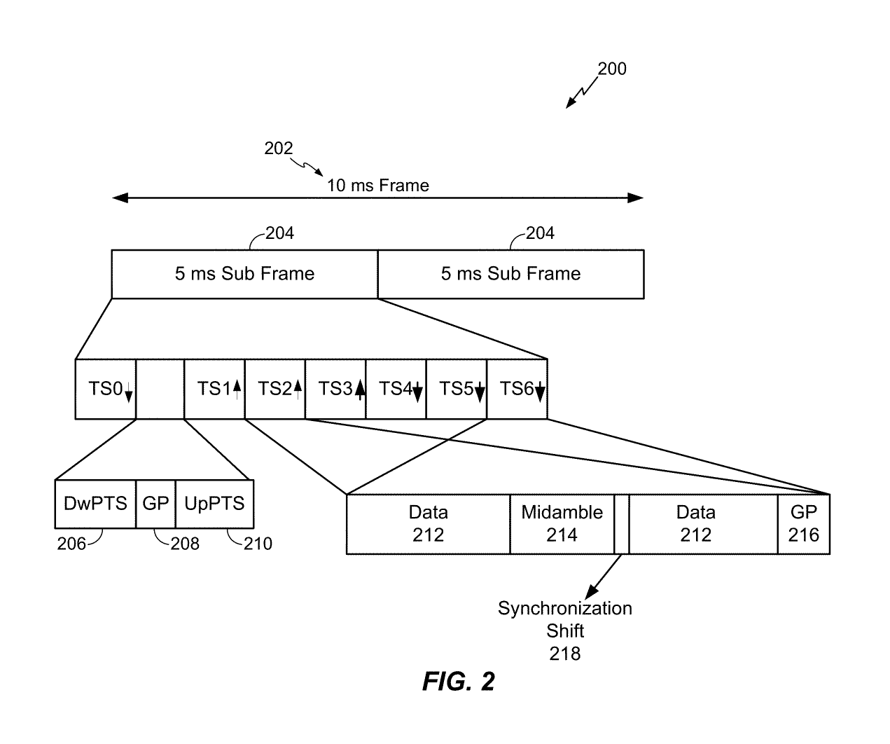

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. SS bits 218 only appear in the second part of the data portion. The SS bits 218 immediately following the midamble can indicate three cases: decrease shift, increase shift, or do nothing in the upload transmit timing. The positions of the SS bits 218 are not generally used during uplink communications.

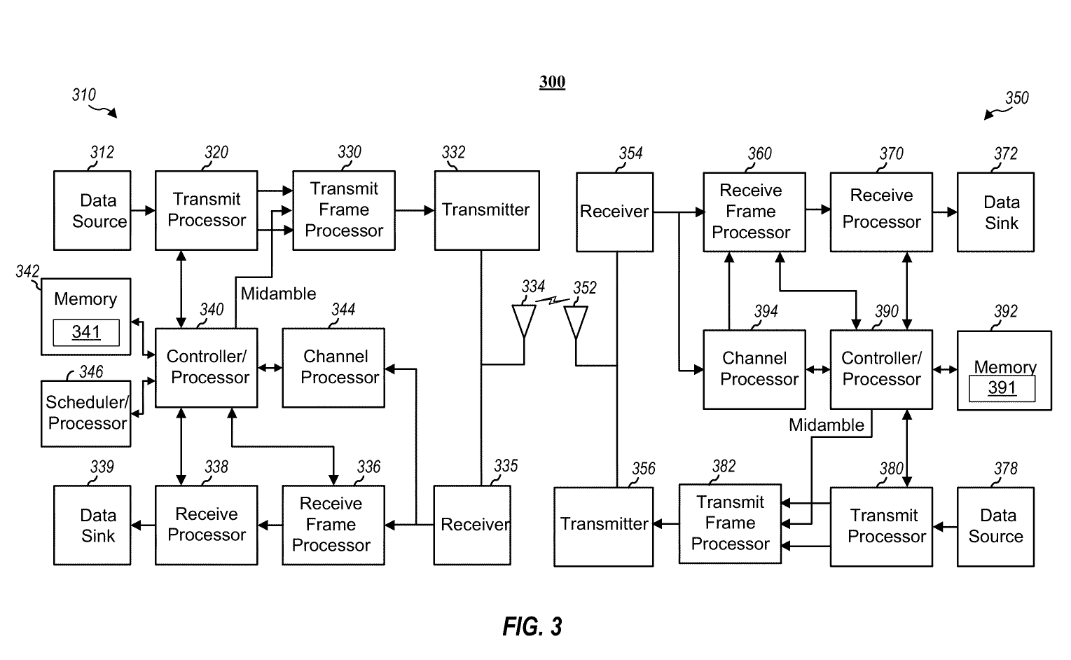

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store a serving neighbor path loss reporting module 391 which, when executed by the controller/processor 390, configures the UE 350 to report a serving neighbor path loss (SNPL). Also, the memory 342 of the node B 310 may store a serving neighbor path loss report receiving module 341 which, when executed by the controller/processor 340, configures the node B 310 to receive a SNPL report. A scheduler/processor 346 at the node B 310 may be used to allocate resources to the UEs and schedule downlink and/or uplink transmissions for the UEs.

TD-HSUPA or HSUPA is an enhancement to TD-SCDMA to improve uplink throughput. In TD-HSUPA, the enhanced uplink dedicated channel (E-DCH) is a dedicated transport channel that features enhancements to an existing dedicated transport channel carrying data traffic.

The enhanced data channel (E-DCH) or enhanced physical uplink channel (E-PUCH) carries E-DCH traffic and schedule information (SI). Information in this E-PUCH channel can be transmitted in a burst fashion.

The E-DCH uplink control channel (E-UCCH) carries layer 1 (or physical layer) information for E-DCH transmissions. The transport block size may be six bits and the retransmission sequence number (RSN) may be two bits. Also, the hybrid automatic repeat request (HARQ) process ID may be two bits.

The E-DCH random access uplink control channel (E-RUCCH) is an uplink physical control channel that carries SI and enhanced radio network temporary identities (E-RNTI) for identifying UEs.

The absolute grant channel for E-DCH (enhanced access grant channel (E-AGCH)) carries grants for E-PUCH transmission, such as the maximum allowable E-PUCH transmission power, time slots, and code channels.

The hybrid automatic repeat request (Hybrid ARQ or HARQ) indication channel for E-DCH (E-HICH) carries HARQ ACK/NAK signals.

The operation of TD-HSUPA may also have the following steps.

Resource Request: First, the UE sends requests (e.g., via scheduling information (SI)) via the E-PUCH or the E-RUCCH to a base station (e.g., Node B). The requests are for permission to transmit on the uplink channels.

Resource Allocation: Second, the base station, which controls the uplink radio resources, allocates resources. Resources are allocated in terms of scheduling grants (SGs) to individual UEs based on their requests.

UE Transmission: Third, the UE transmits on the uplink channels after receiving grants from the base station. The UE determines the transmission rate and the corresponding transport format combination (TFC) based on the received grants. The UE may also request additional grants if it has more data to transmit.

Base Station Reception: Fourth, a hybrid automatic repeat request (Hybrid ARQ or HARQ) process is employed for the rapid retransmission of erroneously received data packets between the UE and the base station.

The transmission of SI (Scheduling Information) may consist of two types in TD-HSUPA: (1) In-band and (2) Out-band. For In-band, which may be included in medium access control e-type protocol data unit (MAC-e PDU) on the E-PUCH, data can be sent standalone or may piggyback on a data packet. For Out-band, data may be sent on the E-RUCCH in case that the UE does not have a grant. Otherwise, the grant expires.

Scheduling Information (SI) includes the following information or fields.

The highest priority logical channel ID (HLID) field unambiguously identifies the highest priority logical channel with available data. If multiple logical channels exist with the highest priority, the one corresponding to the highest buffer occupancy will be reported.

The Total E-DCH Buffer Status (TEBS) field identifies the total amount of data available across all logical channels for which reporting has been requested by the radio resource control (RRC) and indicates the amount of data in number of bytes that is available for transmission and retransmission in the radio link control (RLC) layer. When the medium access control (MAC) is connected to an acknowledged mode (AM) RLC entity, control protocol data units (PDUs) to be transmitted and RLC PDUs outside the RLC transmission window shall also be included in the TEBS. RLC PDUs that have been transmitted but not negatively acknowledged by the peer entity shall not be included in the TEBS. The actual value of TEBS transmitted is one of 31 values that are mapped to a range of number of bytes (e.g., 5 mapping to TEBS, where 24<TEBS<32).

The highest priority logical channel buffer status (HLBS) field indicates the amount of data available from the logical channel identified by HLID, relative to the highest value of the buffer size reported by TEBS. In one configuration, this report is made when the reported TEBS index is not 31, and relative to 50,000 bytes when the reported TEBS index is 31. The values taken by HLBS are one of a set of 16 values that map to a range of percentage values (e.g., 2 maps to 6%<HLBS<8%).

The UE power headroom (UPH) field indicates the ratio of the maximum UE transmission power and the corresponding dedicated physical control channel (DPCCH) code power.

The serving neighbor path loss (SNPL) reports the path loss ratio between the serving cell and all neighboring cells. The base station scheduler incorporates the SNPL for inter-cell interference management tasks to avoid neighbor cell overload.

### Serving Cell and Neighbor Cell Path Loss Reporting

Aspects of the present disclosure are directed to serving cell and neighbor cell path loss reporting. The method may occur in a high speed uplink packet access (HSUPA) system, such as time division-high speed uplink packet access (TD-HSUPA), although other networks are contemplated.

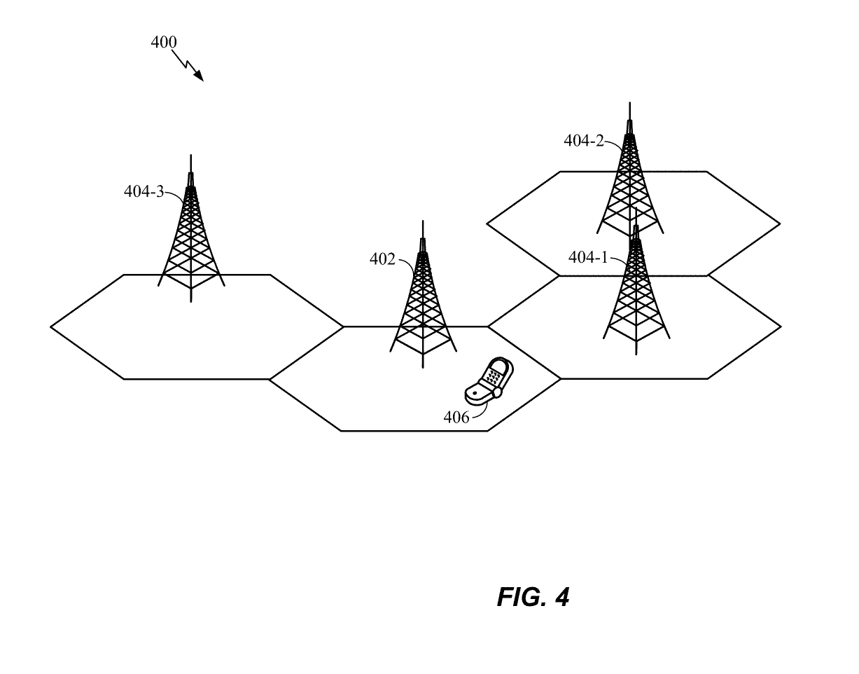

A base station scheduler receives reports of a serving neighbor path loss (SNPL), which indicates the path loss ratio between the serving cell and all neighboring cells in a radio access technology (RAT). Path loss is defined to be the reduction of power density or the attenuation of a signal as it propagates through space or any communications medium. Usually, the SNPL is a single value that is the sum of the path loss values for all the neighbor cells divided by the path loss value for the serving cell. For example, referring to FIG. 4, the UE 406 in the TD-HSUPA system 400 reports an SNPL that is the ratio of the path loss between each neighbor cell 404-1, 404-2, 404-3 (collectively 404) and the UE 406, divided by the path loss between the serving cell 402 and the UE 406.

The base station scheduler uses the SNPL for E-PUCH power resource allocation. That is, the serving cell (or base station) 402 can control the interference to neighbor cells 404 to avoid neighbor cell overload due to high levels of interference.

HSUPA systems in RATs such as wideband-code division multiple access (W-CDMA) may support soft handover. In soft handover, the UE can receive a relative grant, which is a downlink command indicating a neighbor cell uplink overload from multiple cells in an active cell. The relative grant can then be utilized for uplink inter-cell interference management.

That is, in soft handover, the UE can receive relative power grants from multiple cells, which can then be used for uplink inter-cell interference management when the cells in a set are in an overload condition. When the cells in the set are in an overload condition, the overloaded cells can send down commands to request the UE to reduce the HSUPA transmission power. When the cells in the set are not in an overload condition, they can send up commands to request the UE to increase the HSUPA transmission power for high throughput in an Enhanced Relative Grant Channel (E-RGCH).

While HSUPA systems may not support soft handover, the interference to neighbor cells is still determined by the UE location. The UE location controls the path loss between the UE and the serving cell as well as between the UE and the neighbor cells. The reported SNPL is used by the base station scheduler for inter-cell interference management to avoid neighbor cell uplink overloading (e.g., to allocate a maximum allowed E-PUCH transmission power). This reported SNPL is known as SNPL Type 1. SNPL Type 1 considers all the neighbor cells. SNPL Type 2 considers only one neighbor cell, the closest neighbor cell to the UE.

According to the present disclosure, a portion of the neighbor cells are reported as SNPL Type 1. The selected neighbor cells for the SNPL calculation, from the perspective of the UE, are considered close enough to the UE to affect the UE. Farther away neighbor cells are therefore not included in the SNPL Type 1 calculation.

To calculate SNPL Type 1, the UE measures the primary common control physical channel (P-CCPCH) received signal code power (RSCP) of the serving cell and neighbor cells. The P-CCPCH transmit powers of the serving cell and each of the neighbor cells are signaled by the network. Then, the UE calculates the path loss from the serving cell (Lₛₑᵣᵥ), such as the serving cell 402, and from each of the N neighbor cells (L₁, L₂, . . . L_{N}), such as neighbor cells 404-1, 404-2, 404-3.

SNPL Type 1 considers an intra-frequency neighbor cell loss illustrated by the below equation:

$$Φ = \frac{1}{{\sum }_{n = 1}^{N} {L}_{serv} / {L}_{n}}$$

where Φ represents the SNPL Type 1 intra-frequency neighbor cell loss value, Lₛₑᵣᵥ represents the path loss to the serving cell and Lₙ represents the path loss to the nth neighbor cell. The SNPL Type 1 intra-frequency neighbor cell loss value is a single value to report to the serving cell (or base station) 402. The number of neighbor cells impacts this single SNPL Type 1 value.

The metric Φ may be converted into a logarithmic (dB) value “Q” and mapped to a serving and neighbor cell path loss (SNPL) index according to a table, signaled by a high layer, as shown below:

| SNPL Index | Q = 10*log₁₀(f) | |
|---|---|---|
| 0 | | Q < −10 |
| 1 | −10 ≦ | Q < −8 |
| 2 | −8 ≦ | Q < −6 |
| 3 | −6 ≦ | Q < −5 |
| 4 | −5 ≦ | Q < −4 |
| 5 | −4 ≦ | Q < −3 |
| 6 | −3 ≦ | Q < −2 |
| 7 | −2 ≦ | Q < −1 |
| 8 | −1 ≦ | Q < 0 |
| 9 | 0 ≦ | Q < 1 |
| 10 | 1 ≦ | Q < 2 |
| 11 | 2 ≦ | Q < 3 |
| 12 | 3 ≦ | Q < 4 |
| 13 | 4 ≦ | Q < 5 |
| 14 | 5 ≦ | Q < 6 |
| 15 | 6 ≦ | Q < 7 |
| 16 | 7 ≦ | Q < 8 |
| 17 | 8 ≦ | Q < 9 |
| 18 | 9 ≦ | Q < 10 |
| 19 | 10 ≦ | Q < 11 |
| 20 | 11 ≦ | Q < 12 |
| 21 | 12 ≦ | Q < 13 |
| 22 | 13 ≦ | Q < 14 |
| 23 | 14 ≦ | Q < 15 |
| 24 | 15 ≦ | Q < 16 |
| 25 | 16 ≦ | Q < 17 |
| 26 | 17 ≦ | Q < 18 |
| 27 | 18 ≦ | Q < 20 |
| 28 | 20 ≦ | Q < 22 |
| 29 | 22 ≦ | Q < 24 |
| 30 | 24 ≦ | Q < 26 |
| 31 | 26 ≦ | Q |

The higher the SNPL index value reported, the closer the UE is to the serving cell and the farther away the UE is from the neighbor cells. Also, there may be less interference impact on the neighbor cells due to the E-PUCH transmission from the UE. The lower the SNPL index value reported, the farther the UE is from the serving cell (at the edge of the serving cell, for example), and the closer the UE is to the neighbor cells. Also, there will be more interference at the neighbor cells from the UE's E-PUCH transmission. Thus, the power grant is also reduced for a small SNPL index value.

The base station may not know the location of the UE. As a result, the base station sends the same set of neighbor cells—which may be all the neighbor cells—to all of the UEs. For a particular UE, a subset of the neighbor cells includes close neighbor cells that are located close to the UE. The E-PUCH transmission from the UE may impact a few of these close neighbor cells. Because the SNPL Type 1 value typically considers the path loss of all intra-frequency neighbor cells, smaller or lower SNPL values are reported. When the UE reports a small SNPL value to the base station scheduler, the base station scheduler reduces the power grant for the maximum allowed E-PUCH transmission, which degrades the TD-HSUPA throughput.

A power grant may adjust the UE transmission power. A base station may determine a power grant based on a timing advance command, which corresponds to how far the UE is from the base station. The location of neighbor cells may also be used to determine a power grant. In one configuration, the power grant is sent to the UE over the enhanced physical uplink channel (E-PUCH).

Every time the UE performs any high speed uplink transmission, it will introduce interference to neighbor cells located close to the UE. A higher transmission power causes more interference from the UE to its nearby neighbor cells. However, transmission power may not cause interference to neighbor cells located far away from the UE. If the neighbor cells become overloaded with interference, a power grant will be sent to the UE that requests the UE to reduce its transmission power.

According to one aspect of the present disclosure, the UE does not factor all of the neighbor cells (e.g., up to 32 cells) indicated by the network into the SNPL Type 1 calculation. Instead, the UE considers the close neighbor cells. Close neighbor cells can be those cells where the path loss is below a predefined path loss threshold. The close neighbor cells are also the cells that experience interference during uplink transmission. Thus, the other cells above the predefined path loss threshold are not included in the SNPL Type 1 calculation. The base station scheduler also allocates more E-PUCH transmission power or power resources when a higher SNPL Type 1 value is reported. As a result, the TD-HSUPA throughput is improved with more efficient SNPL Type 1 reporting methods. Furthermore, allocating more E-PUCH transmission power to the UE does not introduce interference to neighbor cells that are far away.

According to another aspect of the present disclosure, the predefined path loss threshold may be a static value and may also be based at least in part on a UE maximum transmission power and/or a network indicated maximum allowed transmission power. The predefined path loss threshold may also be an adaptive value determined by the UE current power headroom at the time the UE reports the Type 1 SNPL.

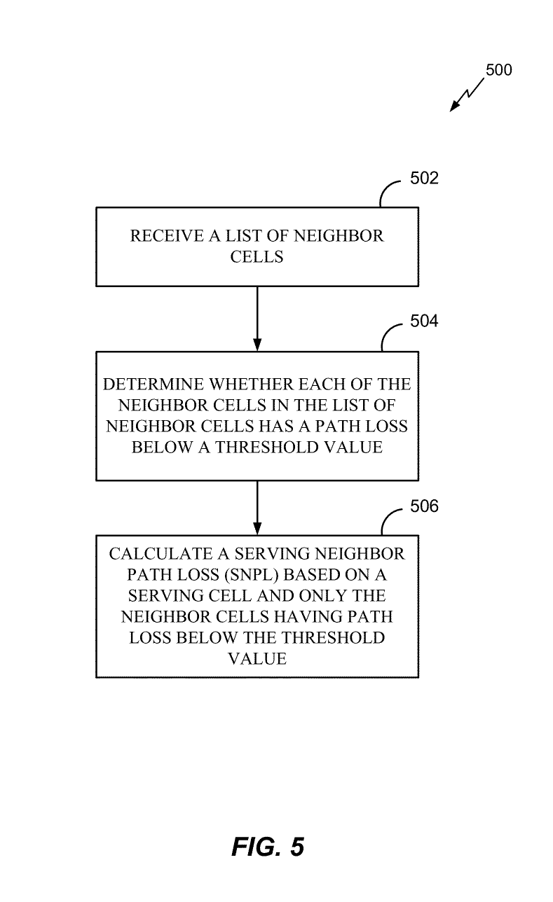

FIG. 5 is a block diagram illustrating a wireless communication method 500 for reporting serving neighbor path loss according to aspects of the present disclosure. In block 502, a user equipment (UE) receives a list of neighbor cells. In block 504, the UE determines whether each of the neighbor cells in the list of neighbor cells has a path loss below a threshold value. In block 506, the UE calculates a serving neighbor path loss (SNPL) based on a serving cell and only the neighbor cells having path loss below the threshold value. In one configuration, the method 500 may include reporting the SNPL. In this configuration, the method 500 may include receiving a power grant in accordance with the reported SNPL. The method 500 may also include adjusting the threshold value based at least in part on a current power headroom at the time of reporting. The method 500 may also include setting the threshold value based on a UE maximum transmission power and/or a network indicated maximum allowed transmission power.

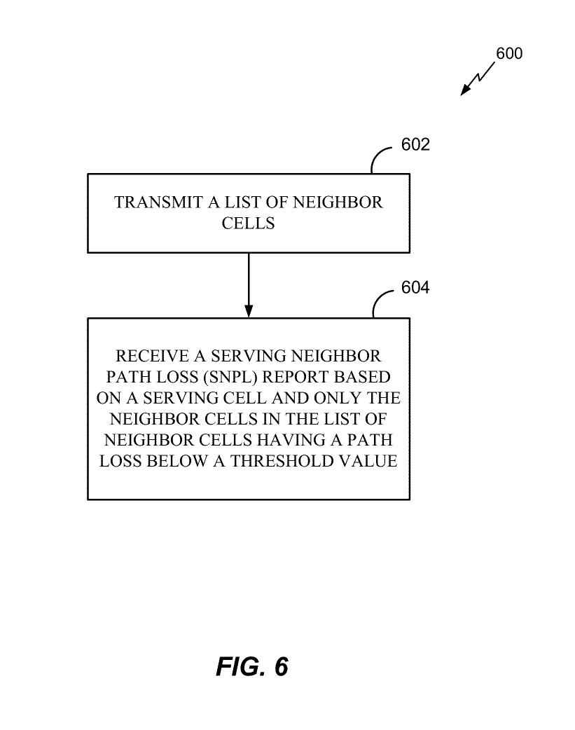

FIG. 6 is a block diagram illustrating another wireless communication method 600 for receiving serving neighbor path loss reports according to aspects of the present disclosure. In block 602, a base station transmits a list of neighbor cells. In block 604, the base station receives, from a UE, a serving neighbor path loss (SNPL) report based on a serving cell and only the neighbor cells in the list of neighbor cells having a path loss below a threshold value.

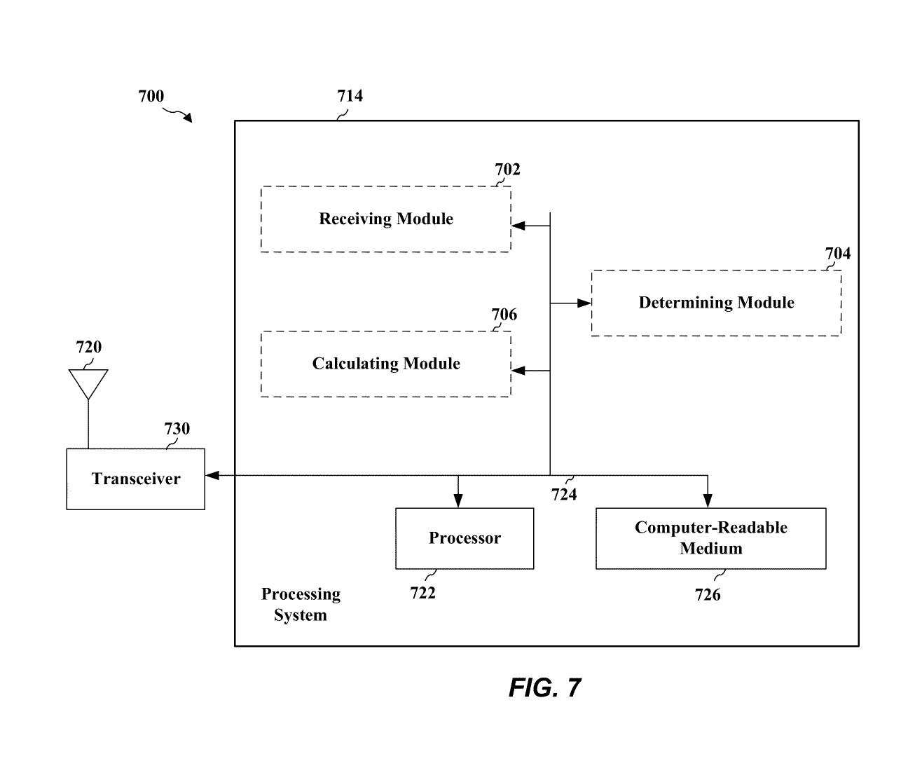

FIG. 7 is a diagram illustrating an example of a hardware implementation for an apparatus 700 employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware modules, represented by the processor 722, the receiving module 702, the determining module 704, the calculating module 706, and the computer-readable medium 726. The bus 724 may also link various other circuits such as timing sources, peripherals, voltage regulators, and power management circuits, which are well known in the art, and therefore, will not be described any further.

The apparatus includes a processing system 714 coupled to a transceiver 730. The transceiver 730 is coupled to one or more antennas 720. The transceiver 730 enables communicating with various other apparatus over a transmission medium. The processing system 714 includes a processor 722 coupled to a computer-readable medium 726. The processor 722 is responsible for general processing, including the execution of software stored on the computer-readable medium 726. The software, when executed by the processor 722, causes the processing system 714 to perform the various functions described for any particular apparatus. The computer-readable medium 726 may also be used for storing data that is manipulated by the processor 722 when executing software.

The processing system 714 includes a receiving module 702 for receiving a list of neighbor cells. The processing system 714 also includes a determining module 704 for determining whether each of the neighbor cells in the list of neighbor cells has a path loss below a threshold value. The processing system 714 further includes a calculating module 706 for calculating a serving neighbor path loss (SNPL) based on the neighbor cells having path loss below the threshold value and a serving cell. The modules may be software modules running in the processor 722, resident/stored in the computer-readable medium 726, one or more hardware modules coupled to the processor 722, or some combination thereof. The processing system 714 may be a component of the UE 350 and may include the memory 392, and/or the controller/processor 390.

In one configuration, an apparatus such as a UE 350 is configured for wireless communication including means for receiving. In one aspect, the above means may be the antenna 352, the receiver 354, the receive processor 370, the controller/processor 390, the memory 392, the serving neighbor path loss reporting module 391, the receiving module 702, the processor 722, and/or the processing system 714 configured to perform the functions recited by the aforementioned means. In another aspect, the aforementioned means may be any module or any apparatus configured to perform the functions recited by the aforementioned means.

In one configuration, the apparatus configured for wireless communication also includes means for determining. In one aspect, the above means may be the controller/processor 390, the memory 392, the determining module 704, the processor 722, and/or the processing system 714 configured to perform the functions recited by the aforementioned means. In another aspect, the aforementioned means may be any module or any apparatus configured to perform the functions recited by the aforementioned means.

In one configuration, the apparatus configured for wireless communication also includes means for calculating. In one aspect, the above means may be the controller/processor 390, the memory 392, the calculating module 706, the processor 722, and/or the processing system 714 configured to perform the functions recited by the aforementioned means. In another aspect, the aforementioned means may be any module or any apparatus configured to perform the functions recited by the aforementioned means.

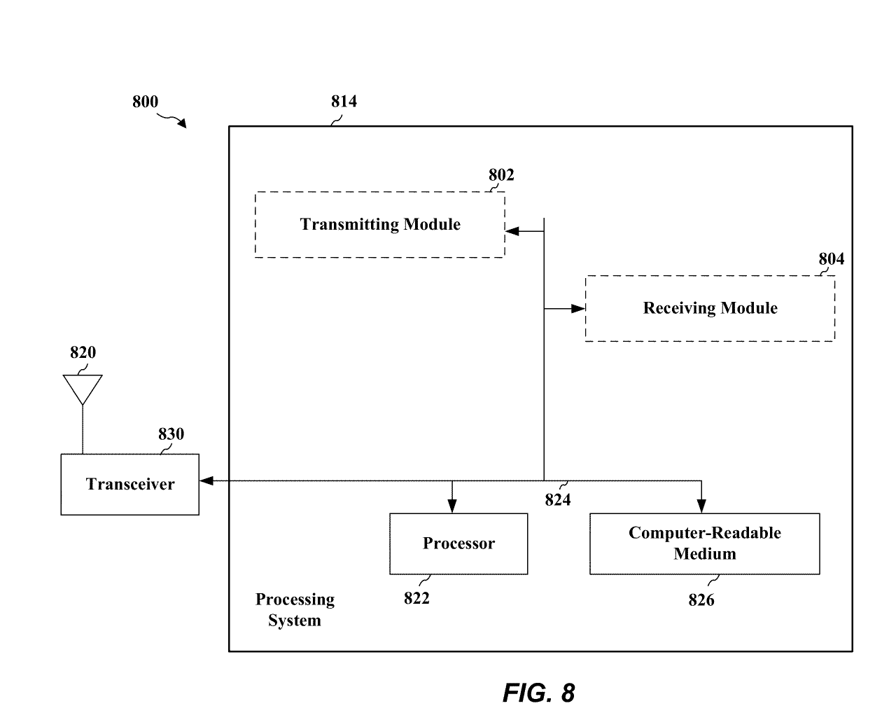

FIG. 8 is a diagram illustrating an example of a hardware implementation for an apparatus 800 employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware modules, represented by the processor 822, the transmitting module 802, the receiving module 804, and the computer-readable medium 826. The bus 824 may also link various other circuits such as timing sources, peripherals, voltage regulators, and power management circuits, which are well known in the art, and therefore, will not be described any further.

The apparatus includes a processing system 814 coupled to a transceiver 830. The transceiver 830 is coupled to one or more antennas 820. The transceiver 830 enables communicating with various other apparatus over a transmission medium. The processing system 814 includes a processor 822 coupled to a computer-readable medium 826. The processor 822 is responsible for general processing, including the execution of software stored on the computer-readable medium 826. The software, when executed by the processor 822, causes the processing system 814 to perform the various functions described for any particular apparatus. The computer-readable medium 826 may also be used for storing data that is manipulated by the processor 822 when executing software.

The processing system 814 includes a transmitting module 802 for transmitting a list of neighbor cells. The processing system 814 also includes a receiving module 804 for receiving a serving neighbor path loss (SNPL) report based on the neighbor cells in the list of neighbor cells having a path loss below a threshold value and a serving cell. The modules may be software modules running in the processor 822, resident/stored in the computer-readable medium 826, one or more hardware modules coupled to the processor 822, or some combination thereof. The processing system 814 may be a component of the node B 310 and may include the memory 342, and/or the controller/processor 340.

In one configuration, an apparatus such as a node B 310 is configured for wireless communication including means for transmitting. In one aspect, the above means may be the antenna 334, the transmitter 332, the transmit processor 320, the controller/processor 340, the memory 342, the serving neighbor path loss report receiving module 341, the transmitting module 802, the processor 822, and/or the processing system 814 configured to perform the functions recited by the aforementioned means. In another aspect, the aforementioned means may be any module or any apparatus configured to perform the functions recited by the aforementioned means.

In one configuration, an apparatus such as a node B 310 is configured for wireless communication including means for receiving. In one aspect, the above means may be the antenna 334, the receiver 335, the receive processor 338, the controller/processor 340, the memory 342, the serving neighbor path loss report receiving module 341, the receiving module 804, the processor 822, and/or the processing system 814 configured to perform the functions recited by the aforementioned means. In another aspect, the aforementioned means may be any module or any apparatus configured to perform the functions recited by the aforementioned means.

Several aspects of a telecommunications system has been presented with reference to TD-SCDMA systems and/or TD-HSUPA. As those skilled in the art will readily appreciate, various aspects described throughout this disclosure may be extended to other telecommunication systems, network architectures and communication standards. By way of example, various aspects may be extended to GSM, as well as UMTS systems such as W-CDMA, high speed packet access plus (HSPA+) and TD-CDMA. Various aspects may also be extended to systems employing long term evolution (LTE) (in FDD, TDD, or both modes), LTE-Advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
receiving a list of neighbor cells;
determining whether each of the neighbor cells in the list of neighbor cells has a path loss below a threshold value; and
calculating a serving neighbor path loss (SNPL) based at least in part on a serving cell and only the neighbor cells having path loss below the threshold value.

2. The method of claim 1, further comprising reporting the SNPL.

3. The method of claim 2, further comprising receiving a power grant in accordance with the reported SNPL.

4. The method of claim 2, further comprising adjusting the threshold value based at least in part on a current power headroom at a time of reporting.

5. The method of claim 2, further comprising setting the threshold value based at least in part on a user equipment (UE) maximum transmission power and/or a network indicated maximum allowed transmission power.

6. The method of claim 1, in which the serving cell is a high speed uplink packet access (HSUPA) cell.

7. The method of claim 1, in which the serving cell is a time division high speed uplink packet access (TD-HSUPA) cell.

8. An apparatus for wireless communication, comprising:
a memory; and
at least one processor coupled to the memory, the at least one processor being configured:
to receive a list of neighbor cells;
to determine whether each of the neighbor cells in the list of neighbor cells has a path loss below a threshold value; and
to calculate a serving neighbor path loss (SNPL) based at least in part on a serving cell and only the neighbor cells having path loss below the threshold value.

9. The apparatus of claim 8, in which the at least one processor is further configured to report the SNPL.

10. The apparatus of claim 9, in which the at least one processor is further configured to receive a power grant in accordance with the reported SNPL.

11. The apparatus of claim 9, in which the at least one processor is further configured to adjust the threshold value based at least in part on a current power headroom at a time of reporting.

12. The apparatus of claim 9, in which the at least one processor is further configured to set the threshold value based at least in part on a user equipment (UE) maximum transmission power and/or a network indicated maximum allowed transmission power.

13. The apparatus of claim 9, in which the serving cell is a high speed uplink packet access (HSUPA) cell.

14. The apparatus of claim 9, in which the serving cell is a time division high speed uplink packet access (TD-HSUPA) cell.

15. A method of wireless communication, comprising:
transmitting a list of neighbor cells; and
receiving a serving neighbor path loss (SNPL) report based at least in part on a serving cell and only the neighbor cells in the list of neighbor cells having a path loss below a threshold value.

16. The method of claim 15, further comprising transmitting a power grant in accordance with the SNPL report.

17. The method of claim 15, in which the serving cell is a time division high speed uplink packet access (TD-HSUPA) cell.

18. An apparatus for wireless communication, comprising:
a memory; and
at least one processor coupled to the memory, the at least one processor being configured:
to transmit a list of neighbor cells; and
to receive a serving neighbor path loss (SNPL) report based at least in part on a serving cell and only the neighbor cells in the list of neighbor cells having a path loss below a threshold value.

19. The apparatus of claim 18, in which the at least one processor is further configured to transmit a power grant in accordance with the SNPL report.

20. The apparatus of claim 18, in which the serving cell is a time division high speed uplink packet access (TD-HSUPA) cell.
